(19) United States
(12) Patent Application Publication
(10) Pub. No.: US 2013/0242852 A1
(43) Pub. Date: Sep. 19, 2013

(54) PORTABLE WiFi SIGNAL REPEATER

(71) Applicant: THINK WIRELESS, INC., Parkland, FL (US)

(72) Inventor: ARGY PETROS, Parkland, FL (US)

(73) Assignee: Think Wireless, Inc., Parkland, FL (US)

(21) Appl. No.: 13/836,474

(22) Filed: Mar. 15, 2013

Related U.S. Application Data
(60) Provisional application No. 61/611,301, filed on Mar. 15, 2012.

(51) Int. Cl. H04W 88/04

(52) U.S. Cl. CPC H04W 88/04
USPC 370/315

(57) ABSTRACT

A portable, battery-powered, wireless WiFi signal repeater is presented. It is placed in very close proximity to a WiFi-enabled device and is capable of improving the. communication link between the device and base station.

### CROSS-REFERENCE TO RELATED APPLICATIONS

This application claims priority to co-pending U.S. Provisional Patent Application Ser. Number 61/611301 filed Mar. 15, 2012 the disclosures of which are hereby incorporated by reference in their entirety.

### FIELD

The embodiments herein relate to portable high-frequency signal repeater systems. It further relates to Wireless Fidelity or WiFi signal repeaters.

### BACKGROUND

WiFi is used extensively In everyday life. It is a mechanism that allows electronic devices to communicate wirelessly over a computer network. A device-enabled with WiFi, such as a smartphone or tablet, can connect to the Internet via a wireless network access point. An access point (or hotspot) has a range of about 65 feet. indoors and approximately 300 feet outdoors. Signal coverage is an important issue. Typical WiFi signal improving devices are: wireless adapters, amplifiers, and Wi-Fi repeaters. Wireless adapters and amplifiers require a physical connection to the WiFi-enabled device. Wireless range-extenders or wireless repeaters can extend the range of an existing wireless network. Range-extenders or repeaters can extend the area of coverage by strategically placing the range-extender or repeater between the router and the WiFi-enabled device. They work well in an office or home environment or where there is access to a location between the router and device, where the signal is relatively strong. However, if there is no access to a location of strong signal between the router and portable device, repeaters do not improve the communication link. In addition, due to their high-power requirement, existing WiFi repeaters need to be plugged into a wall outlet.

### SUMMARY

The repeater according to one embodiment consists of the following components: A high-gain antenna system, a low-gain antenna system, a circuit that detects the strongest signal or channel, amplifies it, and repeats it. The device also consists of a rechargeable battery and charging circuit similar to that of a mobile phone, battery level indicator, at least one programming data port, battery charging port, and signal level indicator. The repeater under the present embodiments can he placed in close proximity to the user's WiFi-enabled device (0 to 6 feet). As soon as the device is turned on, it is capable of detecting and locking to the strongest channel or signal available from the router and starts communicating with the router. It then repeats this signal. If this signal is not the desired signal, the device locks into the next available channel under the user's command. The power of the signal between the device and users WiFi-enabled device may be lower due to the proximity of the device to the Wi-Fi device (low-power communication). This helps improve the device's battery life. The coverage is an area of approximately 6-ft radius.

In another embodiment, the repeater ran be programmed by the user to only repeat the desired channel, in the same way as existing wall-plug versions do today.

The repeater according to the present embodiments should be capable of charging a typical smartphone, tablet, or similar WiFi-enabled device. In addition, a smartphone, tablet or similar device may use the presented repeater's battery.

The main features of some of the embodiments can include the following:
a low-power portable repeater
a repeater that works when placed in very close proximity to a WiFi-enabled device
a battery-operated repeater
a repeater that can power another WiFi-enabled device
a repeater that can charge another WiFi-enabled device.

### BRIEF DESCRIPTION OF THE DRAWINGS

FIG. 1 shows the repeater under the present disclosure and its user-interface components.

FIG. 2 shows a router and a tablet with a low signal level status due to the relatively large distance between the tablet and the router.

FIG. 3 shows the same setup shown in FIG. 1 with the repeater under the embodiments placed in close proximity to the tablet.

FIG. 4 shows an alternate embodiment of the repeater under the present disclosure.

FIG. 5 shows a block diagram of the repeater under the present disclosure utilizing four antennas.

FIG. 6 shows a block diagram of the repeater under the present disclosure utilizing three antennas.

FIG. 7 shows a block diagram of the repeater under the resent disclosure utilizing two antennas.

FIG. 8 shows a block diagram of the repeater under the present disclosure utilizing one antenna.

FIG. 9 shows a dual-feed patch antenna system.

FIG. 10 shows a repeater operation flowchart.

FIG. 11 shows an alternate repeater operation flowchart.

### DETAILED DESCRIPTION OF THE DRAWINGS

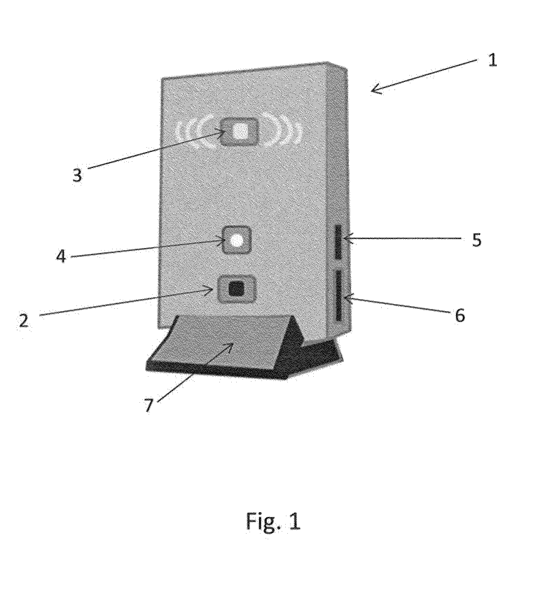

FIG. 1 shows the repeater (1) under the present disclosure and its user-interface components: (2) ON/OFF switch, SCAN button/LED (3), battery status LED (4), USB programming port (5), battery charging port (6), stand (7). Other components are: An internal directional antenna system for communicating with the router of base station, a preferably internal low-gain antenna system for communicating with a WiFi-enabled device, a radio frequency amplifier system, a circuit that detects the strongest signal available, amplifies it, and repeats it. The device also consists of a battery and charging circuit similar to that of a mobile phone.

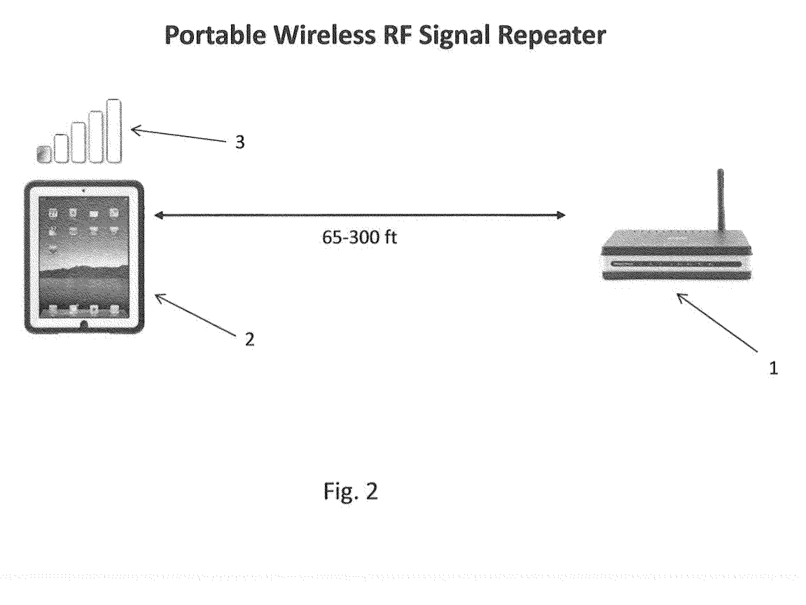

FIG. 2 shows a router (1) and a tablet (2) with a low signal level status (3) due to the relatively large distance between the tablet and the router.

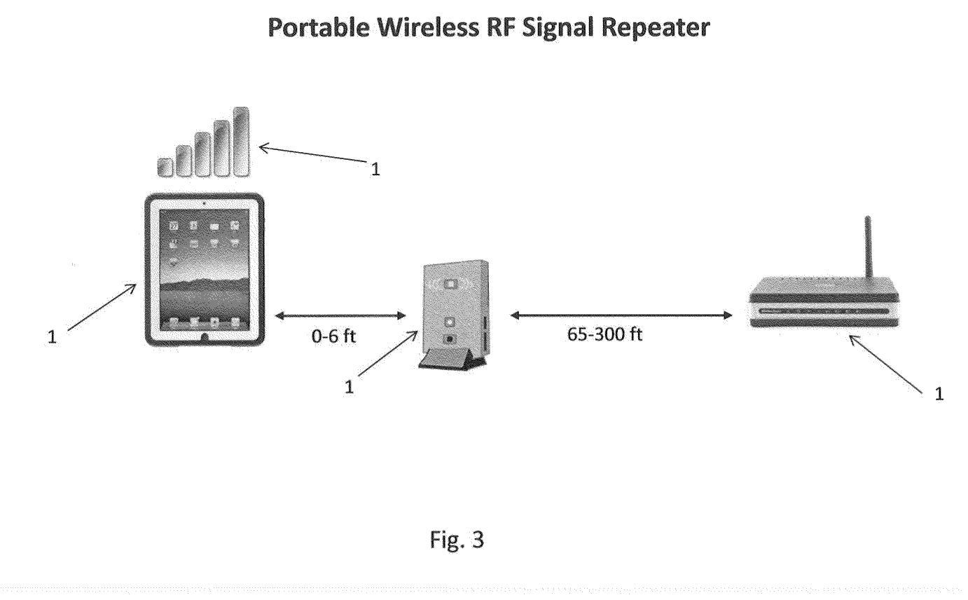

FIG. 3 shows the same setup shown in FIG. 1 with the working repeater (1) under the present embodiments placed in close proximity to the tablet (2), resulting in the tablet's strong signal indicator (3).

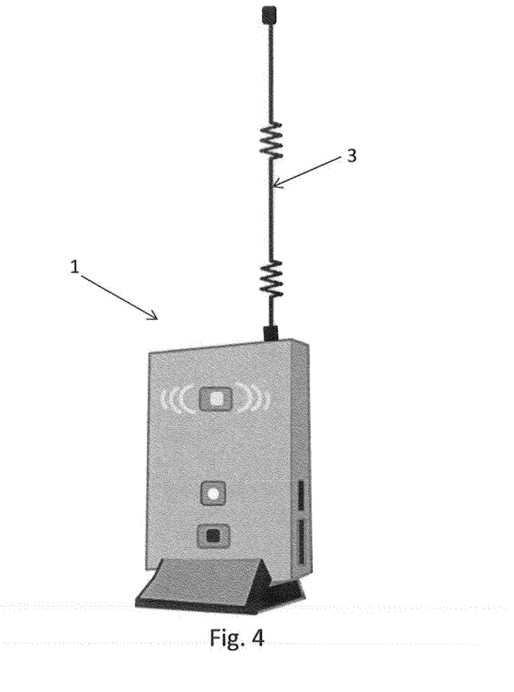

FIG. 4 shows the repeater (1) under the present embodiments utilizing a high gain external omnidirectional antenna (2). This antenna is preferably removable and its minimum gain is 5 dBi. In this configuration, the user does not have to rotate or position the repeater towards a particular direction.

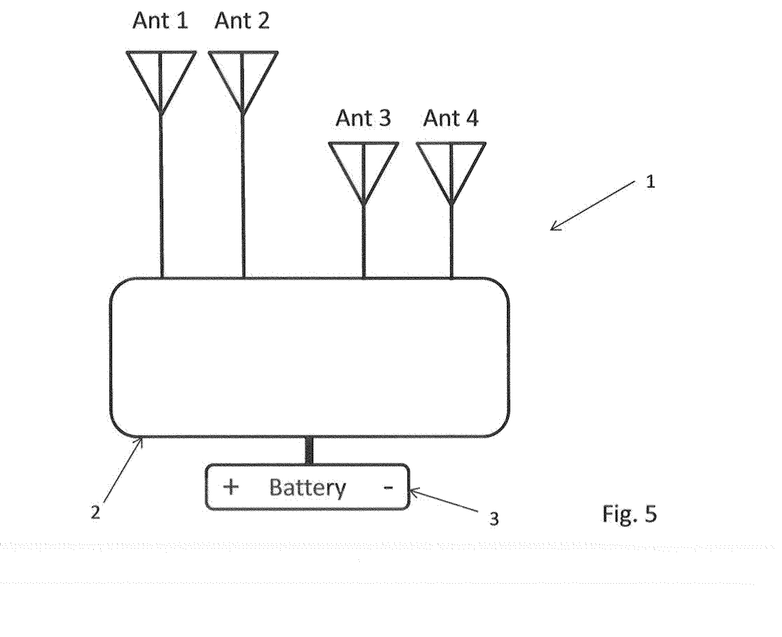

FIG. 5 shows a block diagram of the repeater (1) under the present disclosure utilizing four antennas: ANT1, ANT2, ANT3, and ANT4. ANT1 and ANT2 are part of the internal directional antenna system. This will typically be a dual-feed patch antenna of gain between 5 and 9 dBi. Antennas ANT3 and ANT4 are part of the preferably-internal low gain antenna system. Their gain should be preferably a minimum of −2 dBi. These two antennas can be printed on a dielectric block or printed on the repeater's radio frequency printed circuit board section. The polarization of these two internal antennas is preferably different. In addition, these two antennas may be spaced at least a ¼-wave apart. Block (2) represents all electronic circuitry of the repeater and block (3) is the battery.

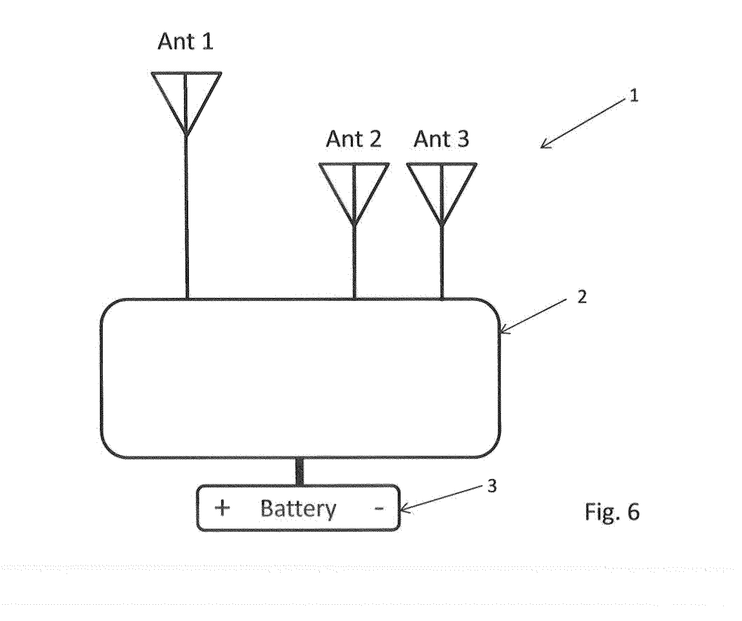

FIG. 6 shows a block diagram of the repeater (1) under the present disclosure utilizing three antennas: ANT1, ANT2, and ANT3. ANT1 represents the internal directional antenna. This will typically be a patch antenna of gain between 5 and 9 dBi. Antennas ANT2 and ANT3 are part of the preferably-internal low gain antenna system. Their gain should be preferably a minimum of −2 dBi. These two antennas can be printed on a dielectric block or printed on the repeaters radio frequency printed circuit board section. The polarization of these two internal antennas is preferably different. In addition, these two antennas may be spaced at least a ¼-wave apart. Block (2) represents all electronic circuitry of the repeater and block (3) is the battery.

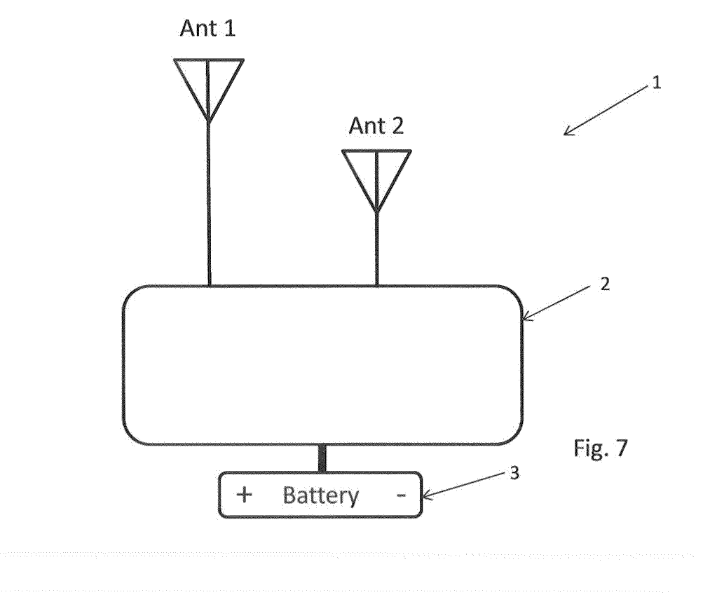

FIG. 7 shows a block diagram of the repeater (1) under the present disclosure utilizing two antennas: ANT1, and ANT2. ANT1 represents the internal directional antenna. This will typically be a patch antenna of gain between 5 and 9 dBi. ANT2 represents a preferably-internal low gain antenna. its gain should be preferably a minimum of −2 dBi. This antenna can be printed on a dielectric block or printed on the repeater's radio frequency printed circuit board section. Block (2) represents all electronic circuitry of the repeater and block (3) is the battery.

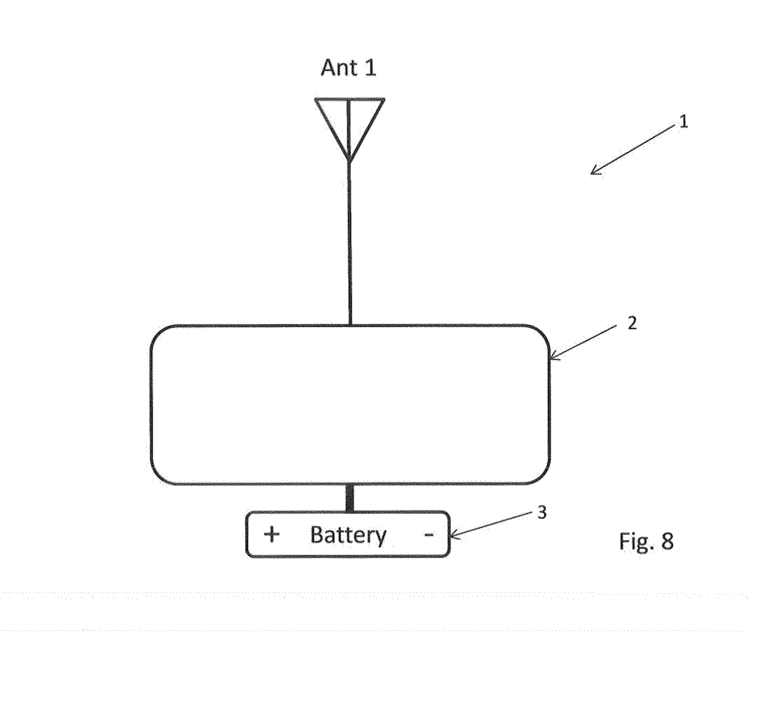

FIG. 8 shows a block diagram of the repeater (1) under the present disclosure utilizing a single antenna: ANTI. ANTI represents a preferably-removable external omnidirectional antenna. This antenna is typically a collinear helix antenna of gain preferably between 5 and 8 dBi. Block (2) represents all electronic circuitry of the repeater and block (3) is the battery.

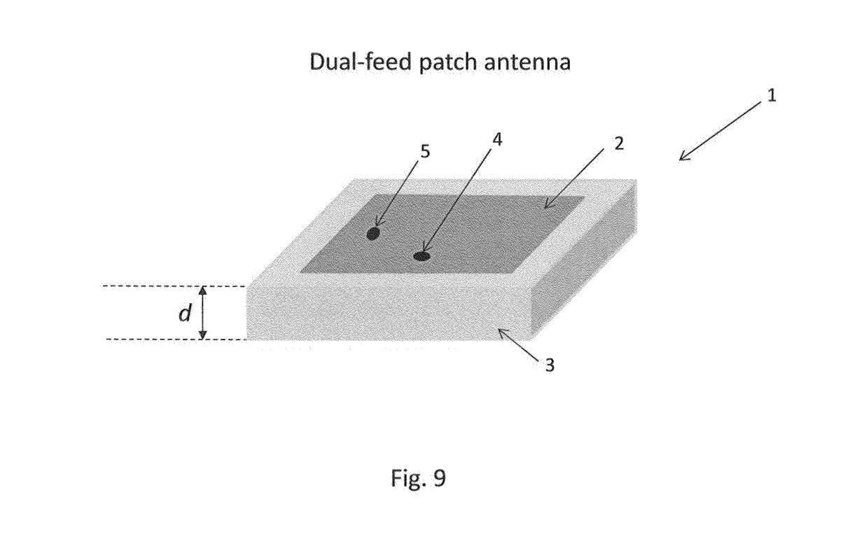

FIG. 9 shows a dual-feed ceramic patch antenna (1), consisting of the metallic surface (2) etched on a dielectric block (3) of thickness d. Feeds (4) and (5) result in a two-antenna systems of different polarization: vertical vs horizontal. The polarization ma also be circular, left hand vs right hand. In the case of a single internal patch antenna of FIG. 6, the polarization is preferably circular. It should be noted that the patch antenna can be an air patch antenna: where a metallic surface is suspended on top of a ground plane and its fed directly or electromagnetically.

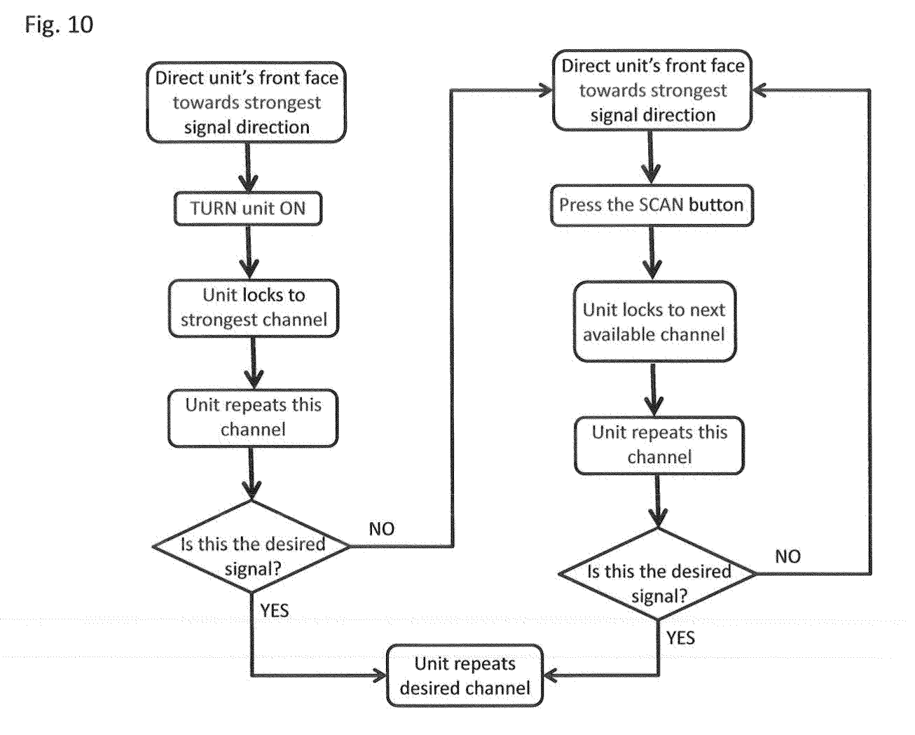

FIG. 10 shows a repeater operation flowchart. This flowchart corresponds to the repeater utilizing an internal directional antenna system. The repeater is placed in close proximity (0 to 6 feet) to WiFi-enabled device. The user points the repeater's front face to the direction of the strongest router signal and turns it ON. This is because the maximum directional antenna gain direction is at the front of the repeater. Only the high gain or directional antenna system communicates with the router. The repeater starts scanning for WiFi signals. There are 3 signal lights on the repeater front cover: green, yellow, red, corresponding to a strong, marginal, and poor signal, respectively. The unit locks to the strongest signal (or channel) and starts communicating with the router. If this signal is not the desired signal, the user presses the “SCAN” button and the repeater locks to the next available channel. The signal power between the device and router is the maximum allowed FCC limit. The signal between the device and user's WiFi-enabled device is preferably lower due to the proximity of the device to the WiFi-enabled device (low-power communication). This helps improve the repeater's battery life. The repeater's signal coverage may be an area of approximately 6-ft radius but can be increased if needed.

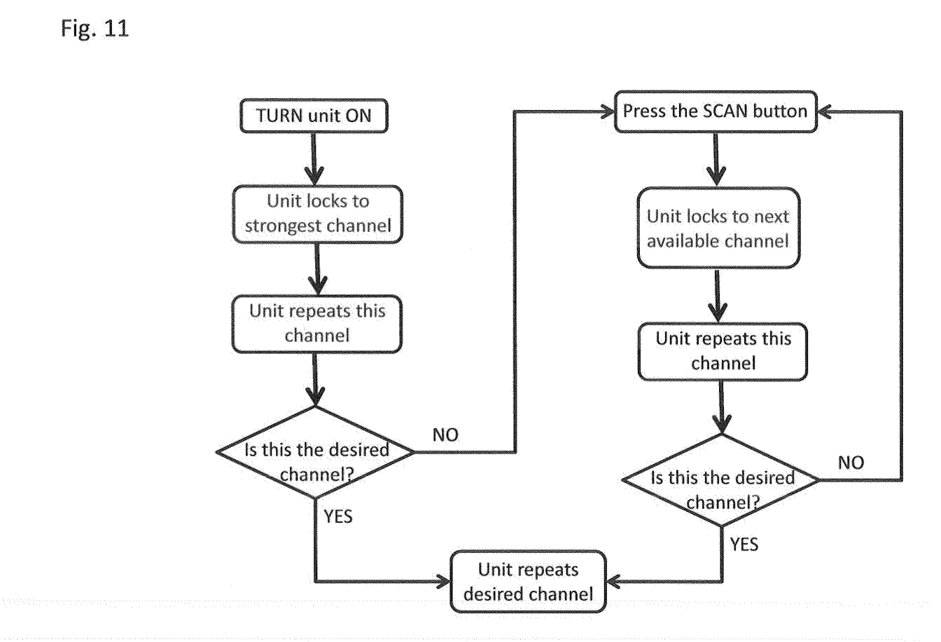

FIG. 11 shows an alternate repeater operation flowchart. In this embodiment, the user does not need to point the repeater to a particular direction. This is because the directional antenna is omnidirectional: the gain is the same along a 360-deg area. All other aspects of the repeater's operation are the same.

1. A portable wireless fidelity signal repeater, comprising:
a high gain directional antenna system used to communicate with a base station; and
a low gain antenna system used to communicate with a wireless fidelity enabled device;
wherein the high gain directional antenna system provides a minimum gain of +5 dBi and
wherein the low gain antenna system provides a minimum gain of −2 dBi.

2. The portable wireless fidelity signal repeater of claim 1, wherein the low gain antenna system is configured to work in close proximity to the wireless fidelity enabled device.

3. The portable wireless fidelity signal repeater of claim 2, wherein close proximity is within 10 feet or less of the wireless fidelity enabled device.

4. The portable wireless fidelity signal repeater of claim 1, wherein the portable wireless fidelity signal repeater is configured to charge a battery of the wireless fidelity enabled device.

5. The portable wireless fidelity signal repeater of claim 1, wherein the portable wireless fidelity signal repeater is configured to serve as an alternative power source for the wireless fidelity enabled device.

6. The portable wireless fidelity signal repeater of claim 1, wherein the wireless fidelity enabled device is one of a smartphone, a tablet computer, or laptop computer, or gaming/entertainment device.

6. The portable wireless fidelity signal repeater of claim 1, wherein the high gain directional antenna system comprises at least one patch antenna.

7. The portable wireless fidelity signal repeater of claim 1, wherein the high gain directional antenna system comprises at least one dual feed patch antenna.

8. The portable wireless fidelity signal repeater of claim 6, wherein the low gain antenna system comprises at least one or more antennas printed on is dielectric block or on a repeater's radio frequency printed circuit board section.

9. The portable wireless fidelity signal repeater of claim 8, wherein the polarization of at least two of the one or more antennas printed have different polarization.

10. The portable wireless fidelity signal repeater of claim 8, wherein the spacing of at least two of the one or more antennas printed are at least a b 1/4 wave apart.

11. The portable wireless fidelity signal repeater of claim 6, wherein the at least one patch antenna is an air patch antenna with a metallic surface suspended on top of a ground plane and it's fed directly or electromagnetically.

12. A method at a repeater having at least high gain antenna and a low gain antenna, comprising:
directing the high gain antenna toward a strongest signal direction as measured by the repeater;
locking the repeater to the strongest signal received from the strongest signal direction; and
repeating the strongest signal to a wireless fidelity device using the low gain antenna.

13. The method of claim 12, wherein the method comprises determining if the strongest signal is a desired channel and continuing to repeat the strongest signal if the strongest signal is the desired channel.

14. The method of claim 12, wherein the method comprises determining if the strongest signal is a desired channel and selectively scanning for a next strongest signal if the strongest signal is not the desired channel.

15. The method of claim 14, wherein the next strongest channel is repeated if the next strongest channel is the desired channel.

16. A method at a repeater having at least high gain antenna and a low gain antenna, comprising:
turning on the repeater:
locking the high gain antenna to a strongest signal as measured by the repeater;
repeating the strongest signal to a wireless fidelity device using the low gain antenna;
determining if the strongest signal is a desired channel;
continuing to repeat the desired channel if the strongest channel is the desired channel; and
selectively scanning for a next available channel if the strongest channel is not the desired channel.

17. The method of claim 16, wherein the method comprises repeating the next available channel when the strongest channel is not the desired channel.

18. The method of claim 17, wherein the method comprises continuing to repeat the next available channel when the next available channel is the desired channel.

19. A non-transitory computer-readable storage medium operating in a repeater having at least a high gain antenna and at least a low gain antenna, comprising computer instructions, which when executed by a processor, causes the processor to direct the high gain antenna toward a strongest signal direction as measured by the repeater;
lock the repeater to the strongest signal received from the strongest signal direction; and
repeat the strongest signal to a wireless fidelity device using the low gain antenna.

20. A non-transitory computer-readable storage medium operating in a repeater having at least a high gain antenna and at least a low gain antenna, comprising computer instructions, which when executed by a processor, causes the processor to:
turning on the repeater;
lock the high gain antenna to a strongest signal as measured by the repeater;
repeat the strongest signal to a wireless fidelity device using the low gain antenna;
determine if the strongest signal is a desired channel;
continue to repeat the desired channel if the strongest channel is the desired channel; and
selectively scan for a next available channel if the strongest channel is not the desired channel.
